(19) United States
(12) Patent Application Publication
(10) Pub. No.: US 2009/0149255 A1
(43) Pub. Date: Jun. 11, 2009

(54) Glow Stick for Video Game Machine

(76) Inventor: Qiang Fu, Shenzhen (CN)

Correspondence Address: BYIP, LTD., P.O. BOX 1484, GENERAL POST OFFICE, HONG KONG, CN

(21) Appl. No.: 12/018,810

(22) Filed: Jan. 24, 2008

(30) Foreign Application Priority Data
Dec. 7, 2007 (CN) 200720171420.1

(51) Int. Cl. G06F 17/00

(52) U.S. Cl. 463/37; 463/36

(57) ABSTRACT

A glow stick for a video game machine is provided, in order to impart a glowing function to a remote controller of a Wii™ host and thereby to add further fun when playing the games. To this end, the following technical solutions are provided in this application: a glow stick for a video game machine, which comprises a glow stick and a handle connected with a remote controller of a host, wherein the glow stick and the handle are detachably assembled together, and the glow stick is electrically connected with the handle. As compared to the prior art, an embodiment adds a glowing function to the remote controller of the Wii™ video game host, so that light of various colors such as blue, red and green will be emitted during a game, thus enhancing the player's fun and enjoyment when playing a grapple game with the Wii™ game host.

### CROSS REFERENCE OF RELATED APPLICATION

The present application claims priority of Chinese patent application no. 200720171420.1 filed Dec. 7, 2007.

### FIELD OF THE APPLICATION

The present application relates to a glow stick, and particularly to a glow stick for use in conjunction with a remote controller of a Wii™ video game host.

### BACKGROUND

The Wii™ video game machine, which is a new generation of video game machine developed by Nintendo Company Limited in 2006, is characterized by a motion-sensing remote controller that allows for new playing ways. With such a game machine, various movement of the controller manipulated by a player can be reflected into an ongoing game, which makes it possible for the player to get a easy start and is convenient for use. Unfortunately, as such a remote controller is not provided with a glowing function, deficient aspects will inevitably occur when it is used to play a game, thereby rendering it impossible for the player to enjoy an optimal game experience.

### SUMMARY

This application is intended to provide a glow stick for a video game machine, which will impart a glowing function to a remote controller of a Wii™ host, so as to add further fun to the games.

To this end, the following technical solutions are provided in this application: a glow stick for a video game machine, which comprises a glow stick and a handle connected with a remote controller of a host, wherein the glow stick and the handle are detachably assembled together, and the glow stick is electrically connected with the handle.

The glow stick includes a PC tube, a PP tube, an EVA expandable polyethylene (EPE) tube, a printed circuit board (PCB), light emitting diodes (LEDs) and contact terminals nested together.

The handle includes a main body, a battery holder, contacts, a swivel head and a switch.

The contact kit is a spring-preloaded contact kit, in which contacts are arranged on a contact support in a delta pattern (with three contacting points) and electrically connected with the contact kit.

The glow stick and the handle are fixedly connected through threads formed in the swivel head.

The PCB has a micro-computer unit (MCU) chip disposed thereon.

The glow stick is a plastic part axially riveted together and is provided with a rib structure to prevent reversal assembly.

The switch is a trigger switch and equipped with buttons made of silica gel.

The main body is shaped into a rounded form and formed with a recess to accommodate a player's fingers.

The main body and the remote controller of the host are assembled together without need of a snap joint, and a glass of the remote controller has a protective foam disposed thereon.

As compared to the prior art, the embodiment of the present application adds a glowing function to the remote controller of the Wii™ video game host, so that light of various colors such as blue, red and green will be emitted during a game, thus enhancing the player's fun and enjoyment when playing a grapple game with the Wii™ game host.

### BRIEF DESCRIPTION OF THE DRAWINGS

FIG. 1-1 is a schematic structure of an embodiment.

FIG. 1-1a is a partially enlarged schematic view of a junction between a glow stick and a handle.

FIG. 1-2 is a front view of a handle.

FIG. 1-2a is a partially enlarged schematic view of a swivel head in the handle viewed from an A direction after being assembled.

FIG. 2 is an schematic exploded view.

### DETAILED DESCRIPTION

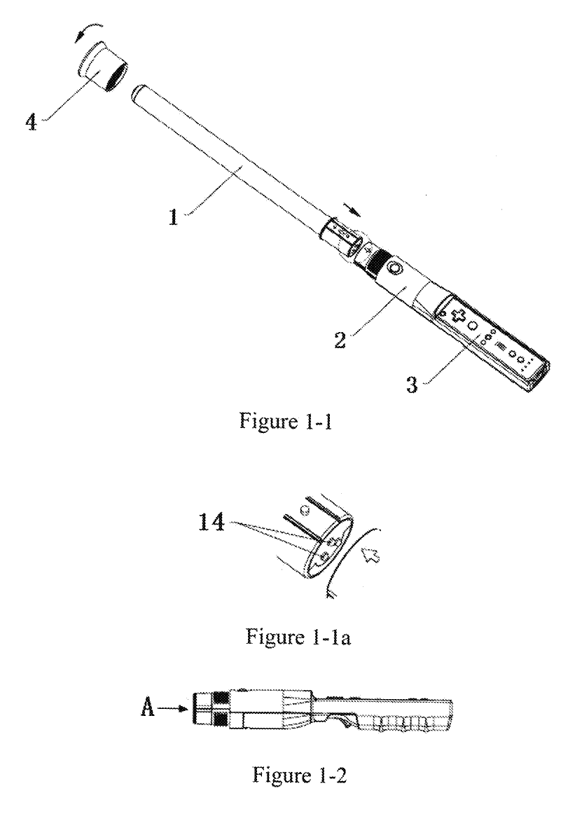

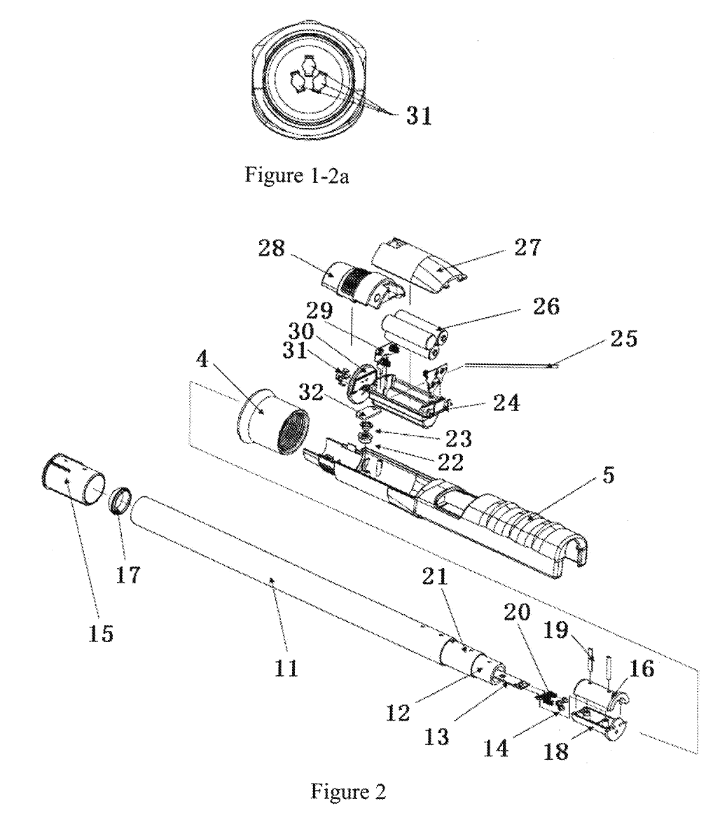

As shown in FIG. 1-1 and FIG. 2, the glow stick for a video game machine includes a glow stick 1 and a handle 2 connected with a remote controller (Wii™ game handle) 3 of a host. The glow stick 1 and the handle 2 are detachably assembled together and electrically connected with each other. The glow stick 1 includes a PC tube 11, a PP tube 21, an EVA expandable polyethylene (EPE) tube 12, a printed circuit board (PCB) 13, light emitting diodes (LEDs) and contact terminals 14 nested together, in which the PC tube 11 has a PC tube cap 17 disposed on a top end thereof, which is fixed by a PC tube fixing support 15. The PCB 13, one end of which is fixed by an upper cover 16, a lower cover 18 of a PCB fixing support and shanks 19, is positioned within the EVA EPE tube 12, and is connected with contact terminals 14 and a spring 20 therein. The EVA EPE tube 12 and the misty PP tube 21 function to protect the LEDs and the PCB 13 against damage by external knocking force and to soften and homogenize light rays from the LEDs. The outermost PC tube 11 functions to withstand impact and knocking actions and delivers a satisfactory light transmission performance. Furthermore, as the PC tube 11 is designed as a round tube with a round head, it is safe to use and will cause no harm to the user. The glow stick 1 is formed as a plastic part axially riveted together, thus rendering the assembling process much simpler. The plastic glow stick 1 and the handle 2 have a respective indicating arrow etched thereon corresponding to each other, which, in combination with the rib structure for prevention of reversal assembly, will facilitate assembly by a player. The handle 2 includes a main body 5, a main body cover 28, a battery pack 26, a battery holder 24, a battery holder cover 27, battery electrode pieces 29, contacts 31, a contact support 30, a swivel head 4 and a switch. The swivel head 4 which is adapted to fixedly connect the glow stick 1 with the handle 2 adopts a reliable threaded connection for safe and secure connection between the glow stick 1 and the handle 2.

Further, the swivel head 4 is electroplated to improve aesthetic appearance of the product. As depicted in FIGS. 1-1, 1-1a, 1-2, 1-2a and 2, the contacts 31 are fixed by a contact support 30, and the contacts 31 distributed in a delta pattern (with three contacting points) on the contact support 30 and the three contact terminals 14 on the glow stick 1 are connected to a power supply in a spring-preloaded way, thereby to ensure easy detachment and good conductive performance. The main body 5 is shaped into a round form, and is formed with a recess therein to accommodate the player's fingers for improved comfort. The remote controller 3 of the Wii™ host and the main body 5 are assembled together by means of a structure free of snap joints to ease assembly and disassembly thereof. A glass of the remote controller 3 has an additional protective foam disposed thereon to prevent fracture thereof when being knocked. The switch, which is a trigger switch including a button 22, a rubber matt 23, and a small PCB 32, is simple and easy to operate, and employs silicon gel buttons to provide a comfort touch feeling, thereby adding further fun in using the glow stick. Three batteries sized AA are used here as the battery pack 26 to achieve good portability, and a lifting strip 25 is provided in the battery holder 24 to facilitate removal of the battery pack 26.

A micro-computer unit (MCU) chip is employed to periodically detect every 5 milliseconds (ms) whether the button is pressed down or not. If the button is pressed down, the MCU chip will be enabled to determine whether the glow stick is in a glowing mode or a blackout mode. In case of a blackout mode, the MCU chip will send five pulse sequences with an interval of 70 ms to turn on transistors, so that the LEDs will be lighted up in a streaming way beginning from the lowermost LEDs. Accordingly, five series of controlled switch circuits, each of which is formed by 4 or 5 LEDs operated in parallel and connected with a transistor, are lighted up successively. Then when the MCU chip detects another press on the button, the MCU chip will be enabled to determine whether the glow stick is in a glowing mode or a blackout mode. In case of a glowing mode, the MCU chip will send five pulse sequences also with an interval of 70 ms to turn off the transistors, so that the LEDs will black out in a streaming way beginning from the uppermost LEDs. Accordingly, five series of controlled switch circuits, each of which is formed by 4 or 5 LEDs operated in parallel and connected with a transistor, black out successively until the glow stick blacks out completely. The circuit of the glow stick comprises: a PCB for LEDs, which is configured to connect components of the circuit; a current-limiting resistor configured to control lighting intensity of the LEDs; transistors configured as a switch to control lighting up and blackout of the LEDs; a MCU chip primarily configured to control flickering intervals of the LEDs, i.e., to light up the LEDs successively with an interval of 70 ms; an electrolytic capacitor adapted to filter out noises, thereby to eliminate instability factors in the power supply occurring instantaneously during a grappling game or a knocking process; a goldfinger PCB and a button configured to control the switch of the LEDs; metal contacts configured to connect the power supply with the glow stick; and spring pieces primarily used for battery connection.

When used in conjunction with a remote controller of a Wii™ video game host, the glow stick may emit light of various colors such as blue, red and green and therefore yield a colorful effect, thus enhancing the player's fun and enjoyment when playing a grapple game with the Wii™ game host. Moreover, the glow stick is detachably assembled, which is convenient for transportation, storage and assembly.

It will be appreciated by persons skilled in the art that the present application is not limited to what has been particularly shown and described herein above. In addition, unless mentioned was made above to the contrary, it should be noted that all of the accompanying drawings are not to scale. A variety of modifications and variations are possible in light of the above teachings without departing from scope and spirit of the application.

What is claimed is:

1. A glow stick for a video game machine, comprising a glow stick and a handle connected with a remote controller of a host, wherein the glow stick and the handle are detachably assembled together, and the glow stick is electrically connected with the handle.

2. The glow stick for a video game machine of claim 1, wherein the glow stick comprises a PC tube, a PP tube, an EVA expandable polyethylene (EPE) tube, a to printed circuit board (PCB), light emitting diodes (LEDs) and a contact kit nested together.

3. The glow stick for a video game machine of claim 2, wherein the handle comprises a main body, a battery holder, contacts, a swivel head and a switch.

4. The glow stick for a video game machine of claim 3, wherein the contact kit is a spring-preloaded contact kit, in which contacts are arranged on a contact support in a delta pattern and electrically connected with the contact kit.

5. The glow stick for a video game machine of claim 4, wherein the glow stick and the handle are fixedly connected through threads formed in the swivel head.

6. The glow stick for a video game machine of claim 2, wherein the PCB has a micro-computer unit (MCU) chip disposed thereon.

7. The glow stick for a video game machine of claim 2, wherein the glow stick is a plastic part axially riveted together and is provided with a rib structure to prevent reversal assembly.

8. The glow stick for a video game machine of claim 3, wherein the switch is a trigger switch and equipped with buttons made of silica gel.

9. The glow stick for a video game machine of claim 3, wherein the main body is shaped into a rounded form and formed with a recess to accommodate a player's fingers.

10. The glow stick for a video game machine of claim 3, wherein the main body and the remote controller of the host are assembled together without need of a snap joint, and a glass of the remote controller has a protective foam disposed thereon.
